(19) United States
(12) Patent Application Publication
(10) Pub. No.: US 2026/0013629 A1
(43) Pub. Date: Jan. 15, 2026

(54) FLAT PACK, CLICK-TOGETHER FURNITURE SYSTEMS

(71) Applicant: HOEK HOME LLC, Brooklyn, NY (US)

(72) Inventor: Conor Coghlan, Brooklyn, NY (US)

(21) Appl. No.: 19/337,056

(22) Filed: Sep. 23, 2025

Related U.S. Application Data
(63) Continuation-in-part of application No. 18/033,715, filed on Apr. 25, 2023.
(60) Provisional application No. 63/067,376, filed on Aug. 19, 2020.
(60) Provisional application No. 63/698,275, filed on Sep. 24, 2024.

(51) Int. Cl. A47B 13/00; A47B 3/06; F16B 2/22

(52) U.S. Cl. CPC A47B 13/003; A47B 3/06; F16B 2/22

(57) ABSTRACT

A furniture system includes a tabletop, a leg mount, and a leg assembly. The leg mount defines a central opening and has at least one support surface positioned adjacent one side of the central opening and a locking surface positioned adjacent a second side of the central opening. The cap has a configuration that corresponds to a configuration of the central opening and includes at least one tab positioned to be supported on the at least one support surface. The leg assembly includes a table leg and a resilient tooth. The table leg defines a cutout configured to receive the resilient tooth in cantilevered fashion. The resilient tooth has an upper end portion having an upper end with a tab including an engagement surface that is positioned to engage the locking surface of the leg mount to secure the leg assembly to the leg mount in snap-fit fashion.

### CROSS REFERENCE TO RELATED APPLICATIONS

This application is a continuation in part of U.S. patent application Ser. No. 18/033,715 filed on Apr. 25, 2023 which is a National Stage Application of PCT/US2021/045737, filed Aug. 12, 2021, which claims the benefit of U.S. Provisional Application Ser. No. 63/067,376, filed Aug. 19, 2020, the entire contents of which are incorporated herein by reference.

### TECHNICAL FIELD

This disclosure relates to furniture, and more particularly, to flat-pack, click-together furniture.

### BACKGROUND

Flat-pack, click-together furniture is often assembled by the end user from flat pieces and is thus easy to store and transport in the un-assembled form. Flat-pack, click-together furniture often suffers from instability, and in some instances is made overly complex or uses more permanent fastening or construction methods to stabilize the furniture. This, however, makes the furniture more cumbersome for the end user and reduces some of the portability and ease of use associated with this type of furniture. Additionally, the use of fasteners, such as screws or nails, to stabilize the furniture often prolongs an amount of time required for assembly and perpetuates the difficulty of such assembly.

### SUMMARY

In accordance with an aspect, this disclosure is directed to a flat pack, click-together furniture system that includes a tabletop and a leg. The tabletop has a top side and a bottom side. The bottom side has a chassis system. The chassis system includes a leg mount defining an elongated leg slot. The chassis system further defines a storage slot. The leg is receivable within the storage slot to support the leg within the chassis system in a stored configuration in which the furniture system has a low profile. The leg has a head end portion and a foot end portion. The head end portion has a first branch and a second branch that are receivable within the elongated leg slot. The first branch is separated from the second branch by a pivot channel to enable the first branch to pivot relative to the second branch. The second branch is engageable with a first end portion of the elongated leg slot. The first branch is engageable with a second end portion of the elongated leg slot after the second branch is engaged with the elongated leg slot and after the first branch is pivoted relative to the pivot channel.

In aspects, the first branch may be coupled to the leg by a hinge.

In aspects, the first branch may include a first tab on a first side thereof, and wherein each leg mount may define a first tab recess. The first tab recess may be positioned to receive the first tab when the first branch pivots from a temporary position thereof to a permanent position thereof. The second branch may include a second tab on a first side thereof, and wherein each leg mount may define a second tab recess. The second tab recess may be configured to receive the second tab before the first tab. The second tab may act as a fulcrum about which the respective leg pivots.

In aspects, the plurality of legs may include flexible material. The flexible material may include at least one of HDPE or plywood.

In aspects, each storage slot of the plurality of storage slots includes a locking rib that is receivable between the first and second branches of a respective leg to secure the respective leg within the respective storage slot. Each storage slot may include a protuberance that engages a bottom surface of a respective leg of the plurality of legs to facilitate securement of the respective leg within the respective storage slot.

In aspects, the foot end portion of the leg may be angled relative to the head end portion of the leg.

According to yet another aspect, this disclosure is directed to a flat pack, click-together furniture system. The furniture system includes a tabletop and a leg. The tabletop has a top side and a bottom side. The bottom side has a chassis system. The chassis system includes a leg mount defining an elongated leg slot. The chassis system further defines a storage slot. The leg is receivable within the storage slot to support the leg within the chassis system in a stored configuration in which the furniture system has a low profile. The leg has a head end portion and a foot end portion. The head end portion has a first branch and a second branch that are receivable within the elongated leg slot. The first branch is separated from the second branch by a pivot channel to enable the first branch to pivot relative to the second branch. The second branch is engageable with a first end portion of the elongated leg slot. The first branch is engageable with a second end portion of the elongated leg slot after the second branch is engaged with the elongated leg slot and after the first branch is pivoted relative to the pivot channel.

In aspects, the first branch may include a first tab on a first side thereof, and wherein the leg mount may define a first tab recess. The first tab recess may be positioned to receive the first tab when the first branch pivots from a temporary position thereof to a permanent position thereof.

In aspects, the second branch may include a second tab on a first side thereof, and wherein the leg mount may define a second tab recess. The second tab recess may be configured to receive the second tab before the first tab.

In aspects, the storage slot may include a locking rib that is receivable between the first and second branches of the leg to secure the leg within the storage slot. The storage slot may include a protuberance that engages a bottom surface of the leg to facilitate securement of the leg within the storage slot.

In aspects, the furniture system may further include a shelf assembly that is selectively attachable to the tabletop.

According to yet another aspect, this disclosure is directed to a flat pack, click-together furniture system including a table top having a bottom side, a leg mount, a cap, and a leg assembly. The leg mount is adapted to be mounted to the bottom side of the table top and defines a central opening. The leg mount has at least one support surface positioned adjacent one side of the central opening and a locking surface positioned adjacent a second side of the central opening. The at least one support surface and the locking surface face upwardly towards the table top. The cap has a configuration that corresponds to a configuration of the central opening. The cap includes at least one tab positioned to be supported on the at least one support surface and defines a first recess. The first recess is positioned on a side of the cap opposite to the at least one tab. The leg assembly includes a table leg and a resilient tooth. The table leg has a foot end and a head end. The head end defines a cutout that is configured to receive the resilient tooth, and the resilient tooth has a lower end portion and an upper end portion. The lower end portion is adapted to be connected to the table leg to secure the resilient tooth within the cutout in cantilevered fashion. The upper end portion includes an upper end having a tab including an engagement surface that is positioned to engage the locking surface of the leg mount, and the upper end of the upper end portion is received within the first recess of the cap.

In aspects, the upper end of the upper end portion of the resilient tooth has an outer surface that is radiused.

In aspects, the leg mount includes a lower side positioned adjacent the central opening that is radiused and engages the outer surface of the upper end of the upper end portion of the resilient tooth to urge the upper end portion inwardly into the cutout when the leg assembly is attached to the leg mount.

In aspects, the furniture system includes a metal plate that is adapted to be connected to a lower surface of the cap.

In aspects, the metal plate has a configuration that corresponds to the configuration of the cap.

In aspects, the at least one support surface of the leg mount includes a first support surface and a second support surface.

In aspects, the leg mount includes an alignment member that is positioned between the first support surface and the second support surface.

In aspects, the cap defines a second recess that is positioned to receive the alignment member.

In aspects, the leg mount has a circular configuration.

In aspects, the leg mount has a rectangular configuration.

In aspects, the furniture system includes a wedge member interposed between the leg mount and the bottom side of the tabletop.

In aspects, the table leg defines a longitudinal axis, and the wedge member is configured to angle the table leg to define an angle with a vertical axis between about 10 degrees and about 30 degrees.

In aspects, the cutout is stepped and has a depth that is larger adjacent the upper end portion of the resilient tooth as compared to a depth of the lower end portion of the resilient tooth.

In aspects, the lower end portion of the resilient tooth is connected within the cutout with screws.

In aspects, the lower end portion of the resilient tooth defines two spaced bores that receive the screws to secure the resilient tooth in cantilevered fashion within the cutout.

Further aspects are directed to a leg assembly for a flat pack, click-together furniture system that includes a table leg, a resilient tooth, and a cap. The table leg has a foot end and a head end defining a cutout. The resilient tooth has a lower end portion and an upper end portion. The lower end portion is adapted to be connected within the cutout of the table leg to secure the resilient tooth within the cutout in cantilevered fashion. The cap includes at least one tab and defines a first recess. The first recess is positioned on a side of the cap opposite to the at least one tab, and the upper end of the upper end portion is received within the first recess of the cap.

In aspects, the at least one tab includes a first tab spaced from a second tab.

In aspects, the first tab and the second tab define a second recess.

In aspects, the leg assembly includes a metal plate interposed between the table leg and the cap.

In aspects, the metal plate is welded to the table leg.

### BRIEF DESCRIPTION OF DRAWINGS

The accompanying drawings, which are incorporated in and constitute a part of this specification, illustrate aspects of the disclosure and, together with a general description of the disclosure given above and the detailed description given below, explain the principles of this disclosure, wherein:

FIG. 1 is a bottom, perspective view of a furniture system in a storage configuration in accordance with the principles of this disclosure;

FIG. 2 is a top, perspective view of the furniture system of FIG. 1 in an assembled configuration in accordance with the principles of this disclosure;

FIG. 3 is a bottom, perspective view of FIG. 2;

FIGS. 4A-4D are progressive views illustrating a leg of the furniture system of FIGS. 1-3 being secured to a leg mount of a tabletop of the furniture system of FIGS. 1-3 to dispose the furniture system in the assembled configuration;

FIGS. 5A-5F are progressive views illustrating a leg of the furniture system of FIGS. 1-3 being secured to a storage slot of the tabletop of the furniture system of FIGS. 1-3 to dispose the furniture system in the storage configuration;

FIGS. 6A-6D are progressive views of illustrating the leg of FIGS. 5A-5F being secured to the storage chassis;

FIG. 7A is a perspective view of a tabletop shelf assembly in accordance with the principles of this disclosure, the tabletop shelf assembly shown in an unassembled configuration;

FIG. 7B is a perspective view of the tabletop shelf assembly of FIG. 7A shown in an assembled configuration;

FIGS. 8A-8D are progressive views illustrating a shelf leg of the tabletop shelf assembly being secured to a shelf chassis of a tabletop shelf;

FIGS. 9A and 9B are progressive views illustrating the tabletop shelf assembly of FIG. 7B being secured to another furniture system;

FIGS. 11A-11D are progressive views illustrating the shelf leg of the tabletop shelf assembly of FIG. 7B being coupled to a mounting rib of the furniture system of FIGS. 9A and 9B;

FIGS. 12A and 12B are top and bottom perspective views of another furniture system in assembled configurations in accordance with the principles of this disclosure;

FIGS. 13A and 13B are top and bottom perspective views of still another furniture system in assembled configurations in accordance with the principles of this disclosure;

FIGS. 14A and 14B are top and bottom perspective views of yet another furniture system in assembled configurations in accordance with the principles of this disclosure;

FIGS. 15A and 15B are top and bottom perspective views of another furniture system in assembled configurations in accordance with the principles of this disclosure;

FIGS. 16A and 16B are top and bottom perspective views of yet another furniture system in assembled configurations in accordance with the principles of this disclosure;

FIG. 17 is a side perspective view of an alternative version of a leg assembly and leg mount of the furniture system shown in FIG. 1 with the leg mount separated from the leg assembly;

FIG. 18 is a side perspective exploded view of the leg assembly and the leg mount shown in FIG. 17;

FIG. 19 is a side perspective view of the leg assembly and the leg mount of FIG. 17 assembled;

FIG. 20 is a cross-sectional view taken along section line 20-20 of FIG. 19;

FIG. 21 is a cross-sectional view taken along section line 21-21 of FIG. 17;

FIGS. 22A-22D are progressive views illustrating the leg assembly shown in FIG. 17 being coupled to the leg mount to secure the leg assembly to a tabletop;

FIG. 23 is a side perspective view of the leg assembly and leg mount with a wedge for angling the legs assembly in relation to a tabletop;

FIG. 24 is a side perspective view of the leg assembly and leg mount with an alternate version of the wedge shown in FIG. 20; and

FIG. 25 is a side view of the leg assembly and leg mount shown in FIG. 17 mounted to a tabletop with the wedge shown in FIG. 24.

### DETAILED DESCRIPTION

Aspects of the disclosed systems and methods are described in detail with reference to the drawings, in which like reference numerals designate identical or corresponding elements in each of the several views. In the following description, well-known functions or constructions are not described in detail to avoid obscuring the present disclosure in unnecessary detail.

Furniture systems of this disclosure are flat pack, click-together furniture joint systems.

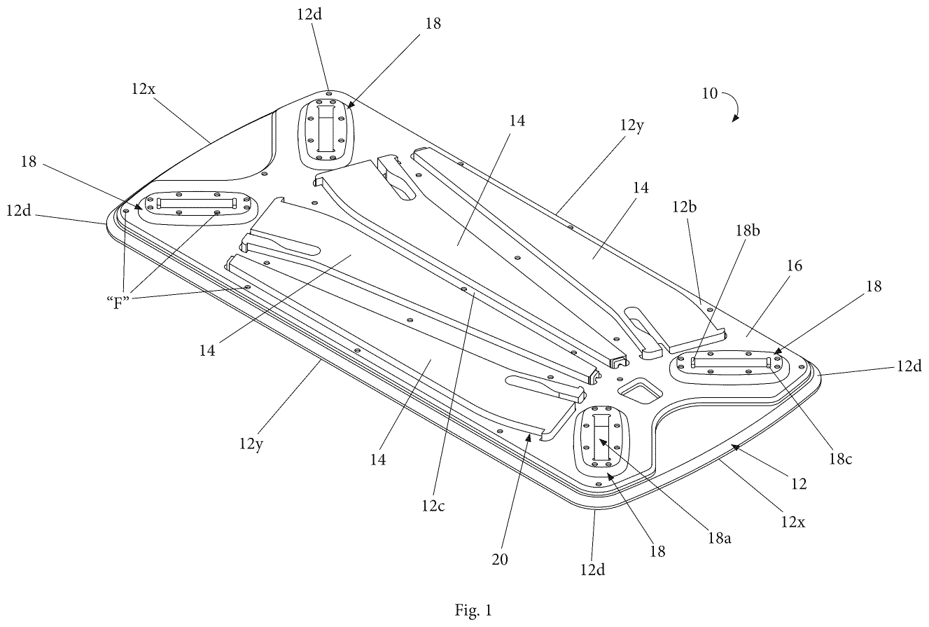

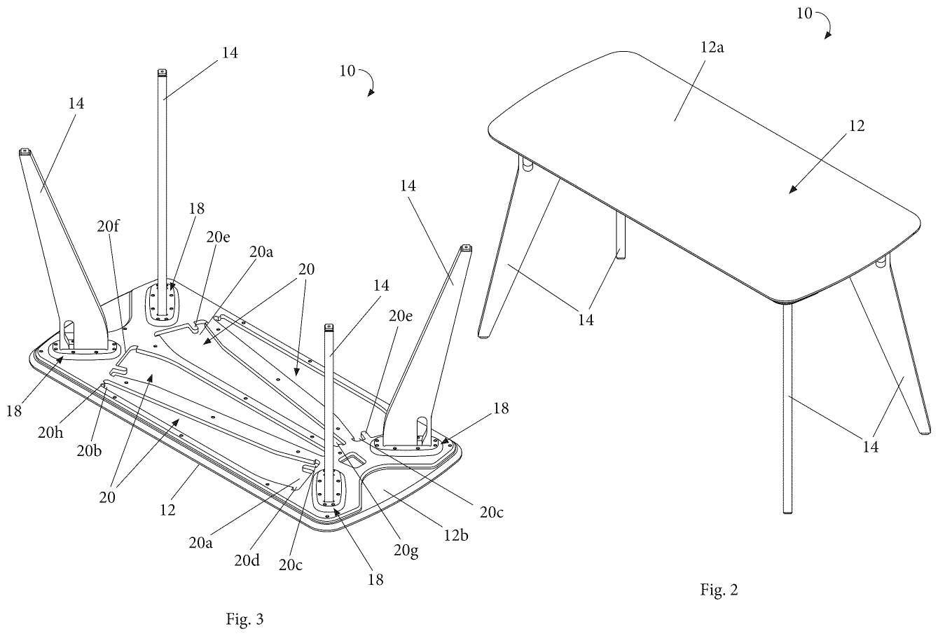

With reference to FIGS. 1-6D, furniture system 10 includes a tabletop 12 and a plurality of legs 14 that snap-fit to a chassis system 16 of the tabletop 12. Tabletop 12 includes a top side 12a, which generally functions as working surface and bottom side 12b that secures legs 14 to tabletop 12. Tabletop 12 also includes long sides 12y and short sides 12x. Chassis system 16 is disposed on bottom side 12b of tabletop 12 and can be secured thereto using, for example, fasteners “F,” such as nails or screws, although any suitable securement technique may be utilized (e.g., adhesive, welding, etc.). Chassis system 16 includes a plurality of leg mounts 18 disposed at spaced apart locations about a periphery of chassis system 16 (e.g., one adjacent to each of the four corners 12d of table top 12). Each leg mount 18 defines an elongated leg slot 18a therein. Elongated leg slot 18a includes an inner end portion 18b and an outer end portion 18c. Inner end portion 18b is positioned closer to a center 12c of tabletop 12 than the respective outer end portion 18c, and outer end portion 18c is disposed closer to one of the respective corners 12d of tabletop 12 than the respective inner end portion 18a. Inner end portion 18b defines posterior tab recess 18d therein, and outer end portion 18c defines an anterior tab recess 18e therein. Leg mounts 18 are configured to secure legs 14 to chassis system 16 to maintain furniture system 10 in an assembled configuration where furniture system 10 has an expansive profile.

Chassis system 16 of furniture system 10 further defines a plurality of storage slots 20 for storing the plurality of legs 14 within chassis system 16 to maintain furniture system 10 in a stored configuration where furniture system 10 has a low profile. Each storage slot 20 is shaped to conform to one of the legs 14. Storage slots 20 include a head end portion 20a and a foot end portion 20b. Head end portion 20a includes an anterior tab cutout 20c on a first side of head end portion 20a and a posterior tab cutout 20d on a second side of head end portion 20a. Head end portion 20a further includes a locking rib 20e that is disposed between anterior and posterior tab cutouts 20c, 20d. Locking rib 20e extends from a first end 20f of storage slot 20 toward a second end 20g of storage slot 20. A protuberance 20h extends from second end 20g of storage slot 20 on foot end portion 20b toward first end 20f of storage slot 20.

Legs 14 of furniture system 10 are selectively detachable from the leg mounts 18 of chassis system 16 and are configured to be stored within storage slots 20 for reducing a profile of the system in a flat pack form for easier storage. Each leg 14 includes a head end 14a and a foot end 14b that is angled relative to head end 14a to enable leg 14 to provide increased support to tabletop 12. Although shown to be at an angle “A” of about 10 to 20 degrees relative to a line orthogonal to a floor, angle “A” may have any suitable angle between 0 and 90 degrees relative to the line orthogonal to the floor.

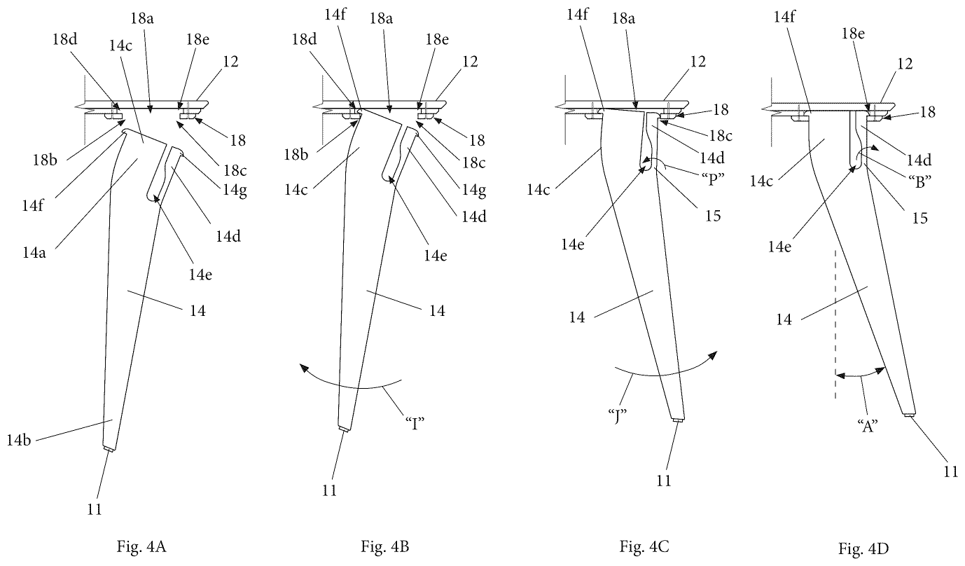

Head end 14a of leg 14 includes a posterior branch 14c and an anterior branch 14d that are separated by a pivot channel 14e that enables anterior branch 14d to pivot from a permanent position thereof (see FIG. 4A) to a temporary position thereof (see FIG. 4C). In particular, anterior branch 14d is coupled to leg 20 via a hinge 15 and is configured to pivot about hinge 15 into pivot channel 14e of leg 14 toward posterior branch 14c, as indicated by arrow “P,” when an actuation force is applied to anterior branch 14d. Such actuation force may be applied, for example, when a user squeezes head end 14a and/or depresses anterior branch 14d toward posterior branch 14c. When the actuation force is removed, anterior branch 14d is configured to pivot back toward an initial position thereof (e.g., biased or urged toward its initial position), and away from posterior branch 14c, as indicated by arrow “B” (see FIG. 4D). At least portions of the legs 14 are made from a flexible material, such as HDPE or plywood. Posterior branch 14c includes a posterior tab 14f that is receivable within posterior tab recess 18d of leg mount 18 to secure posterior branch 14c to inner end portion 18b of leg mount 18. Foot end 14b may be pivoted in a posterior direction about posterior tab 14f, as indicated by arrow “I,” to facilitate insertion of posterior tab 14f into posterior tab recess 18d. Anterior branch 14d includes an anterior tab 14g that is receivable within anterior tab recess 18e of leg mount 18 to secure anterior branch 14d to outer end portion 18c of leg mount 18 when anterior branch 14d pivots back to the initial position thereof. In particular, with posterior tab 14f received within posterior tab recess 18d, foot end 14b can be pivoted in an anterior direction (opposite the posterior direction), as indicated by arrow “J”, whereby posterior tab 14f acts as a fulcrum to pivot anterior branch 14d upwardly into elongated leg slot 18a. Then, with posterior branch 14c and anterior branch 14d disposed within elongated leg slot 18a of leg mount 18, the applied actuation force can be removed so that anterior tab 14g pivots about hinge 15, as indicated by arrow “B,” and into anterior tab recess 18e of leg mount 18 for locking leg 14 to leg mount 18.

Each leg 14 is secured to a respective one of the leg mounts 18 until all four legs 14 are secured to tabletop 12 so that legs 14 can support tabletop 12 off the floor/ground in an assembled configuration (FIG. 2). Each leg 14 can include shoe 11 on a bottom surface of foot end 14b to protect the bottom surface of leg 14 and/or a surface of the floor upon which the furniture system 10 is placed.

When the furniture system 10 needs to be moved and/or stored away, each of the legs 14 can be removed by reapplying actuation force to each of the anterior branches 14d and pivoting the legs 14 out of the respective leg mounts 18 to separate the legs 14 from tabletop 12.

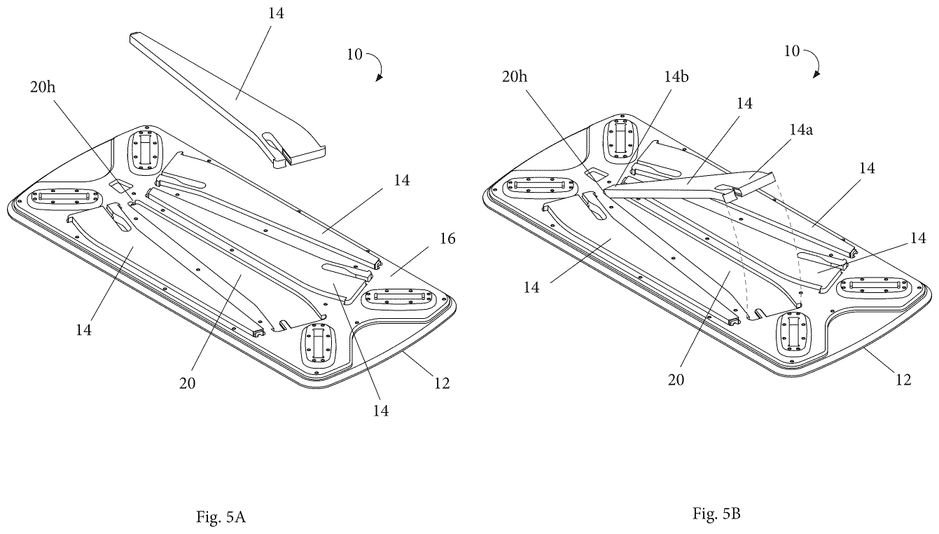

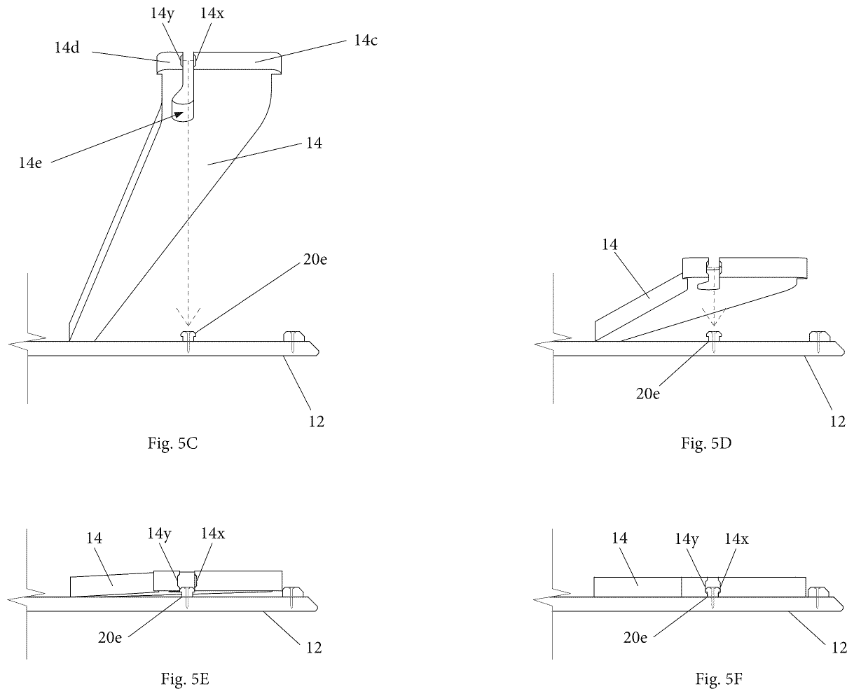

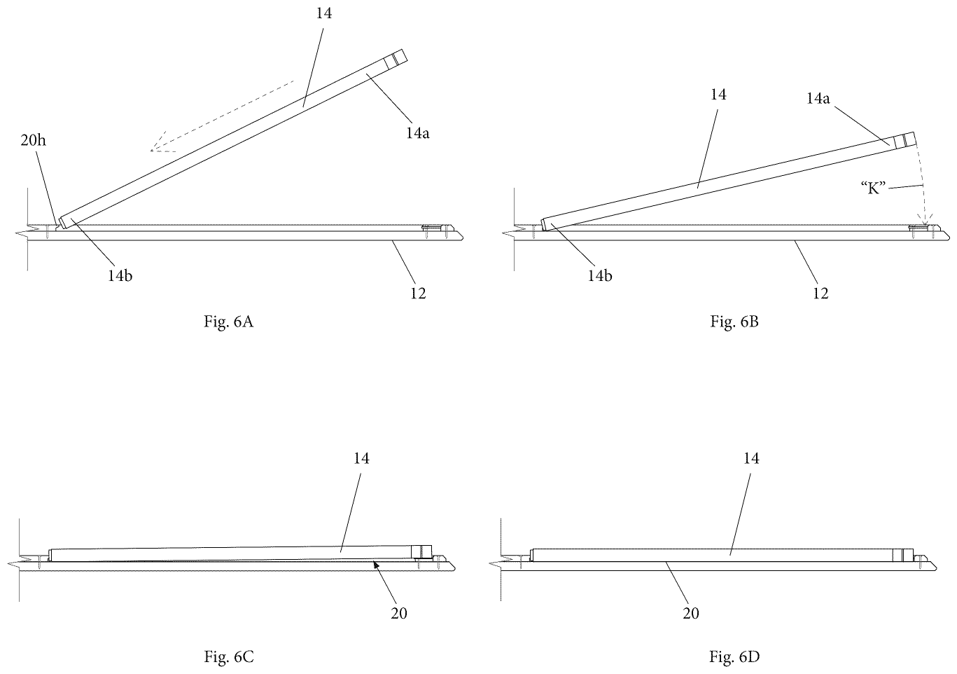

As best seen in FIGS. 5A-6D, to dispose furniture system 10 in a storage configuration, each leg 14 can be inserted into a respective one of storage slots 20. To help facilitate securement of legs 14 to storage slots 20 of tabletop 12, anterior branch 14d of leg 14 defines a rib channel 14y in a posterior surface thereof, and posterior branch 14c of leg 14 defines a rib channel 14x in an anterior surface thereof that is disposed in registration with rib channel 14y of anterior branch 14d. Rib channels 14y, 14x are disposed in communication with pivot channel 14e and positioned to align with locking rib 20e of storage channel 20.

To effectuate insertion of a leg 14 into a storage slot 20, the respective leg 14 is angled relative to the respective storage slot 20 such that foot end 14b of the respective leg 14 can be positioned against protuberance 20h of the respective storage slot 20 (see FIGS. 5B and 6A). Leg 14 is then pivoted downwards into storage slot 20 about protuberance 20h, as indicated by arrow “K” until rib channels 14y, 14x receive locking rib 20e of storage channel 20 (e.g., friction-fit). Locking rib 20e and protuberance 20h of storage slot 20 secures leg 14 within storage slot 14 so that furniture system 10 can be easily stored. To remove leg 14, anterior and posterior branches 14d, 14c can be separated away from locking rib 20e so that leg 14 can be pivoted out of storage slot 20 as desired to re-assemble furniture system 10.

As can be appreciated, in aspects, the relative positions of the posterior and anterior branches 14d, 14c (and all the corresponding structure of furniture system 10) can be reversed.

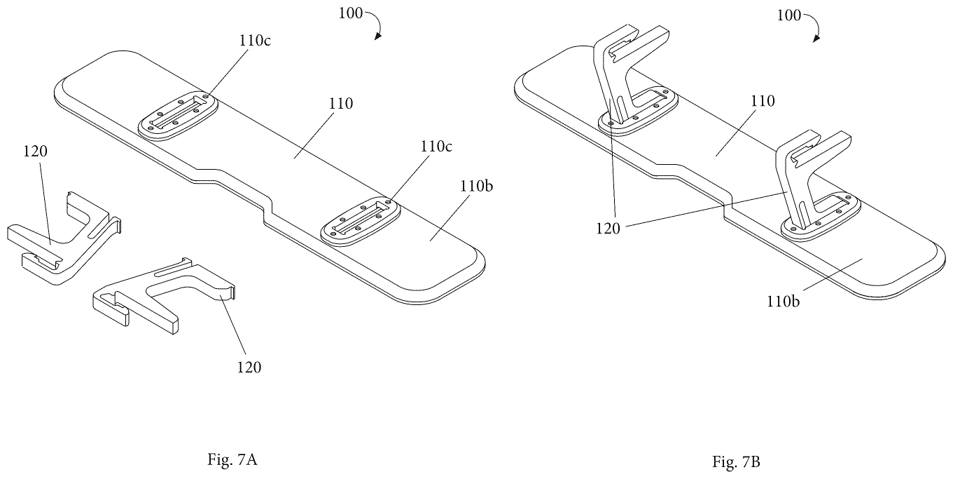

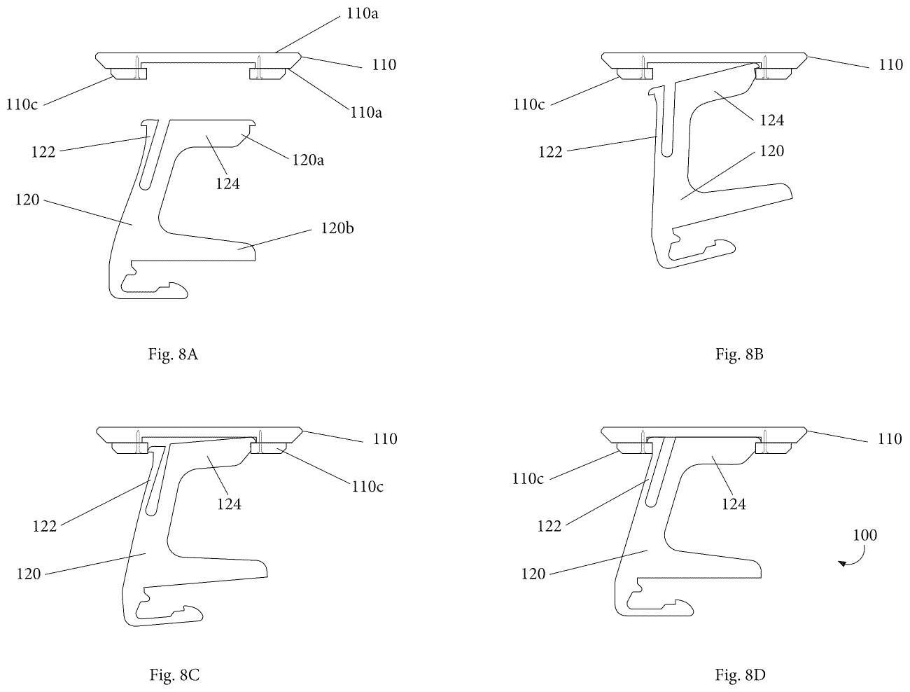

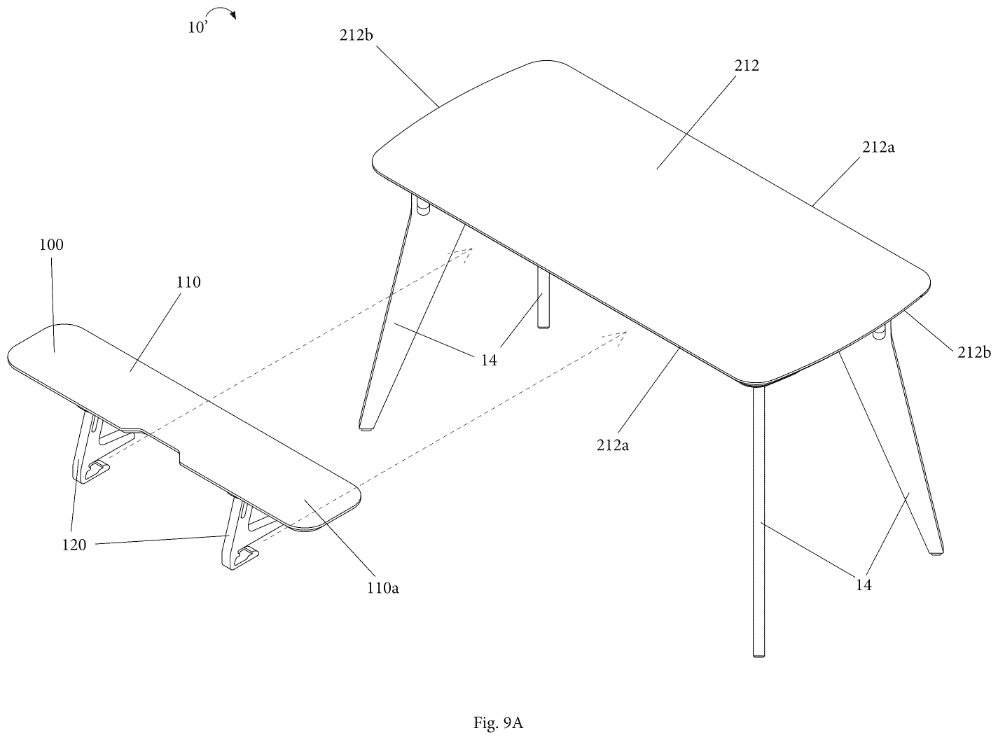

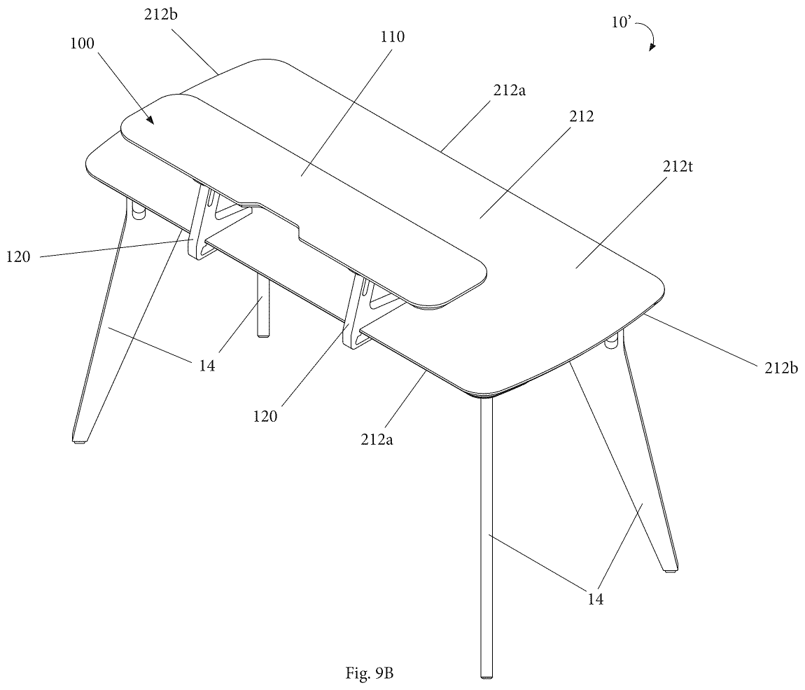

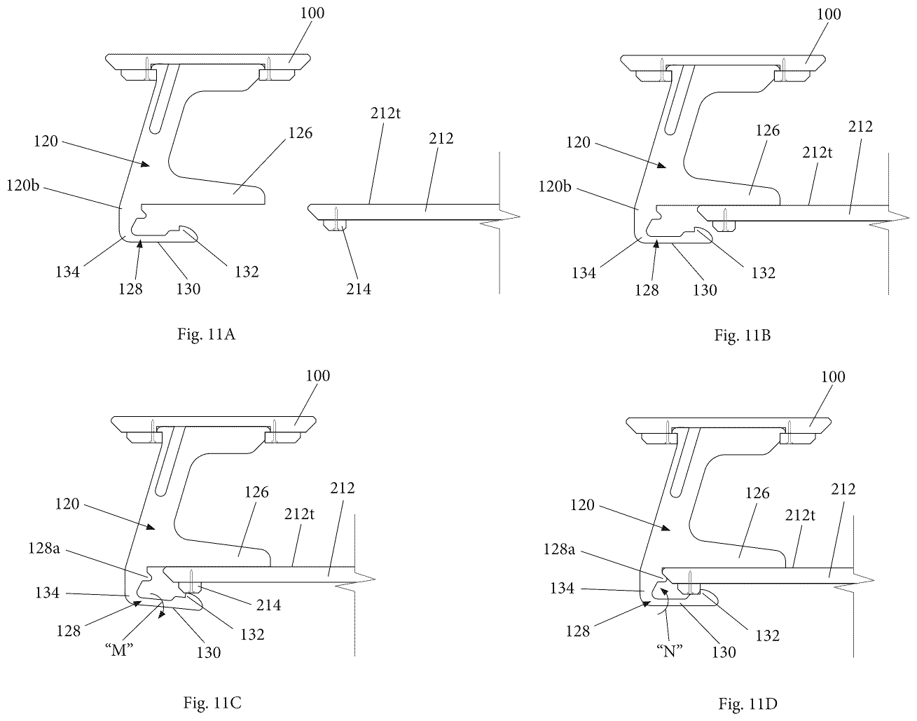

Turning now to FIGS. 7A-11D, one furniture system 10′ can include a tabletop shelf assembly 100 that is selectively attachable to a tabletop 212 of furniture system 10′. Tabletop 212 of furniture system 10′ is substantially similar to tabletop 12 but includes a shelf rib 214 extending along a long side 212a of a bottom surface of tabletop 212. In some aspects, shelf rib 212a can extend along a short side 212b of the bottom surface of tabletop 212. Tabletop shelf assembly 100 includes a shelf assembly 110 and arm members 120 that couple shelf assembly 110 to tabletop 12. Shelf assembly 110 includes a top surface 110a and a bottom surface 110b that supports arm mounts 110c. Arm mounts 110c are substantially similar in structure and operation to leg mounts 18 of tabletop 12 and therefore are not described in further detail in the interest of brevity. Arm member 120 includes a head end portion 120a and a foot end portion 120b. Head end portion 120a includes a first branch 122 that is substantially similar to anterior branch 14d of head end portion 14a of leg 14, and a second branch 124 that is substantially similar to posterior branch 14c of head end portion 14a of leg 14. As seen in FIGS. 8A-8D, first and second branch 122, 124 of head end portion 120a couple to arm mount 110c in substantially the same manner as anterior and posterior branches 14d, 14c of leg 14 to leg mount 18. Thus, since head end portion 120a of arm member 120 is substantially similar in structure and operation as head end portion 14a of leg 14, head end portion 120a of arm member 120 will not be described in further detail in the interest of brevity.

With reference to FIG. 11A, foot end portion 120b of arm 120 includes a balance bar 126 that extends distally from arm member 120 and that is configured to slidably mount onto a top surface 212t of tabletop 212. Foot end portion 120b further includes a flexible hook 128 that depends from a proximal end portion of balance bar 128. Flexible hook 128 includes a table abutment 128a configured to engage a side surface of tabletop 212 and a flexible finger 130 having a distal tooth 132. Flexible finger 130 is pivotable about a proximal hinge 134, as indicated by arrows “M” and “N,” between an unflexed position (see FIG. 11B) and a flexed position (FIG. 11C) as flexible finger 130 cams along shelf rib 214 of tabletop 212 as tabletop shelf assembly 100 is moved distally into approximation with tabletop 212 to secure tabletop shelf assembly 100 to tabletop 212. To remove tabletop shelf assembly 100 flexible finger 130 is flexed downwardly, as indicated by arrows “M,” so that flexible hook 128 can cam proximally along shelf rib 214 as tabletop shelf assembly 100 is slid proximally away from tabletop 212 to separate tabletop shelf assembly 100 from tabletop 212.

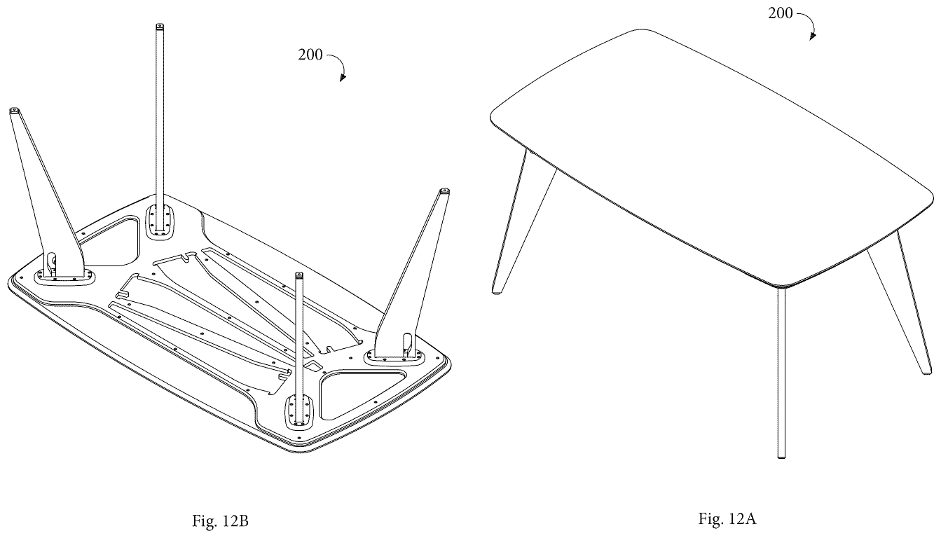

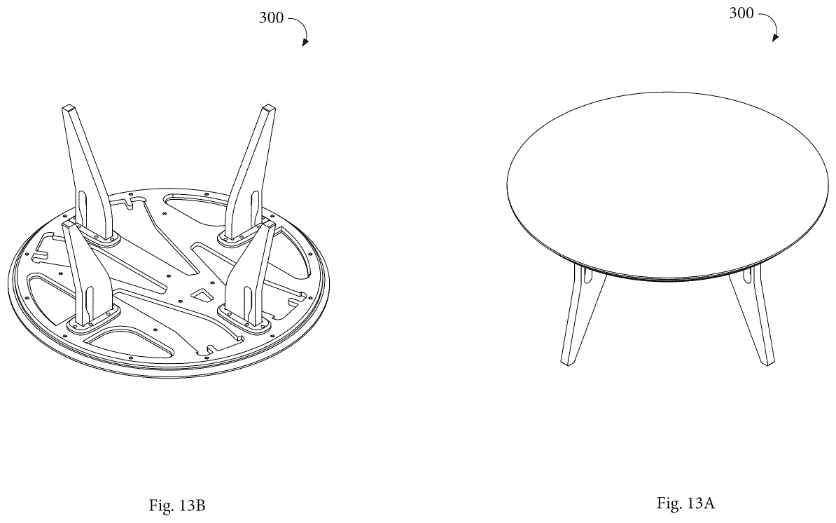

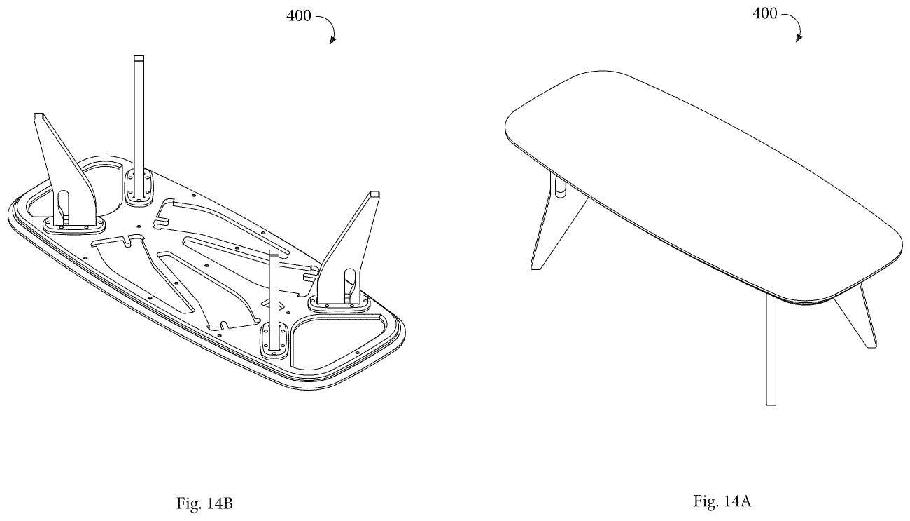

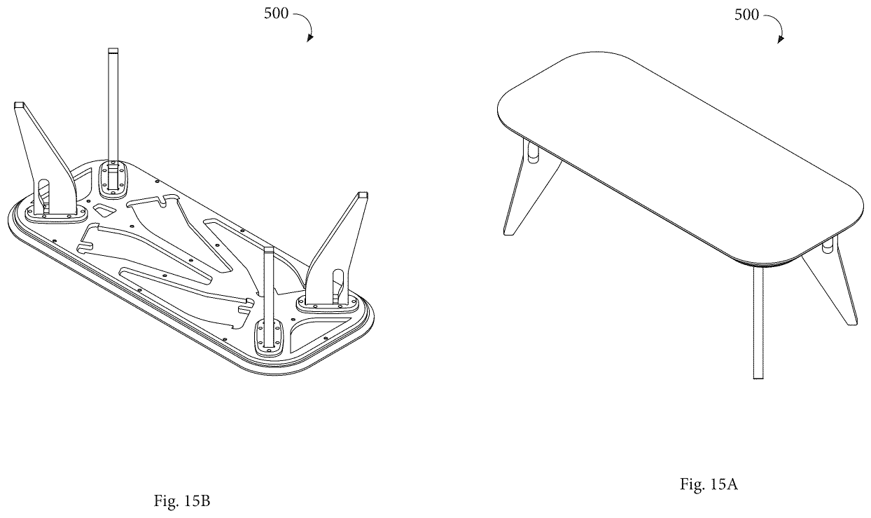

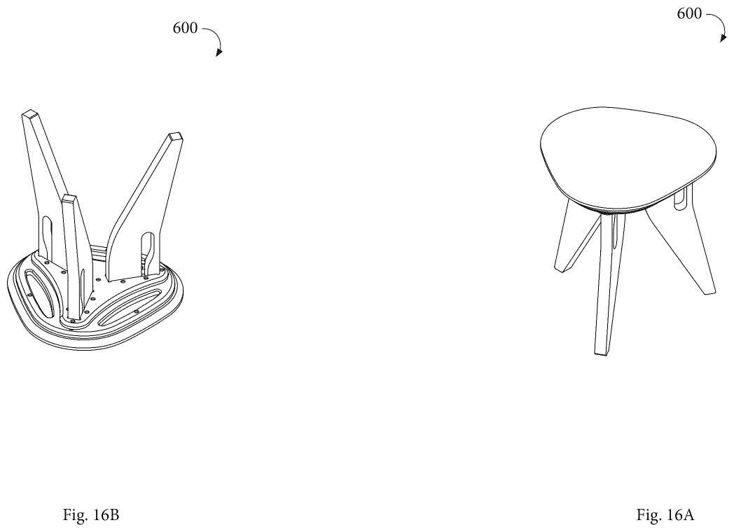

Turning now to FIGS. 12A-16B, furniture systems of this disclosure can have any variety of shapes and configurations as illustrated by furniture systems 200, 300, 400, 500, and 600. For instance, the furniture systems of this disclosure may be in the form of a table (e.g., dining, coffee, side, or end table), bench, stool, or other suitable furniture.

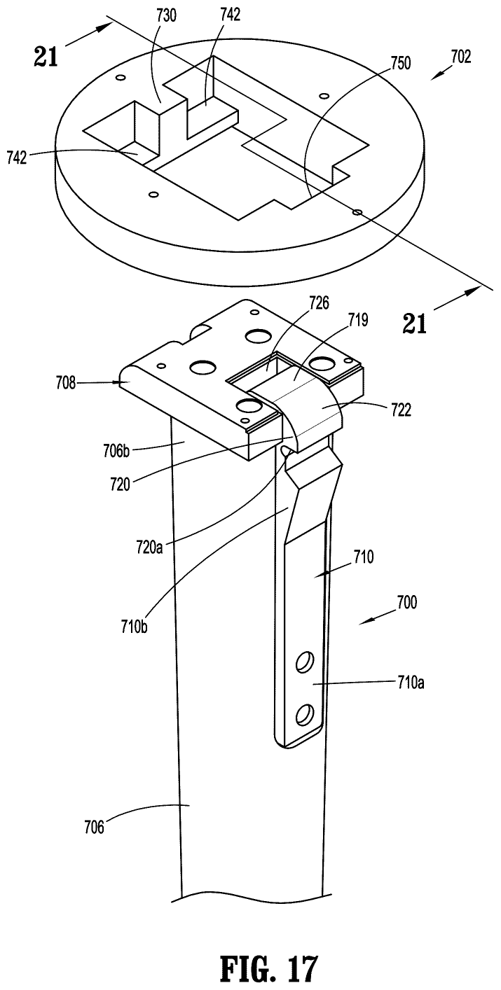

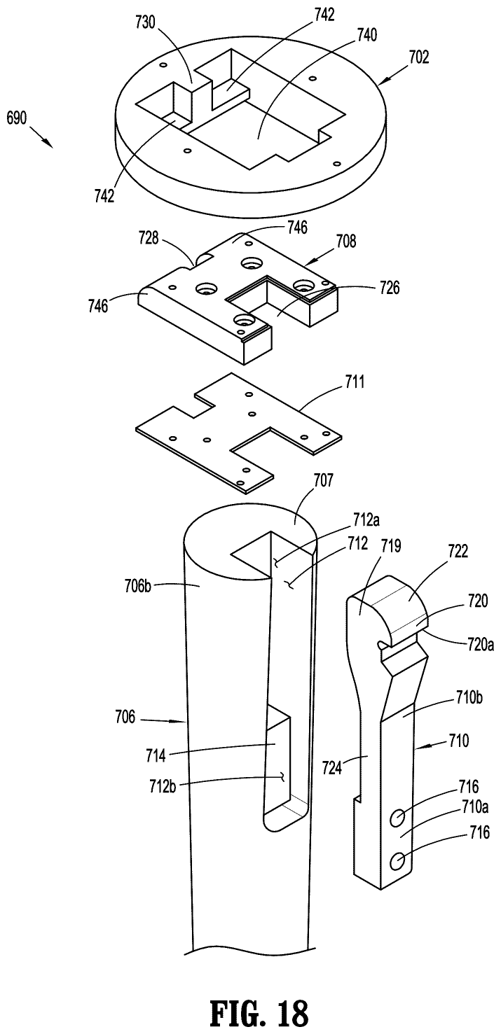

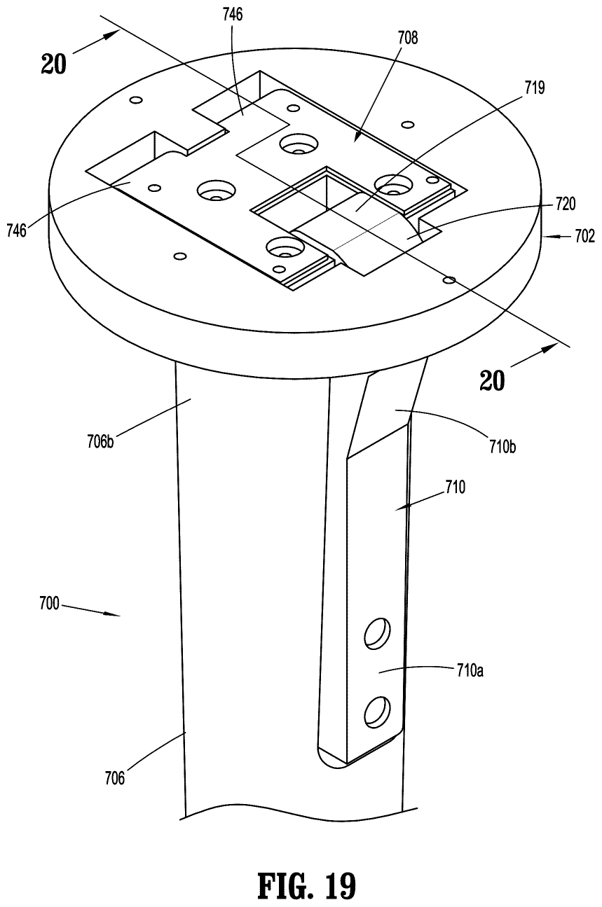

FIGS. 17-21 illustrate another version of the flat pack, click-together furniture system 690, which includes a leg assembly 700 and leg mount 702 for releasably mounting the leg assembly 700 to a tabletop 704 (FIG. 20) according to further aspects of the disclosure. The leg assembly 700 includes a table leg 706, a cap 708, and a flexible, resilient tooth 710. In aspects of the disclosure, the leg assembly 700 also includes a metal plate 711 (FIG. 18) that has a configuration that corresponds to the configuration of the cap 708 and is described in further detail below.

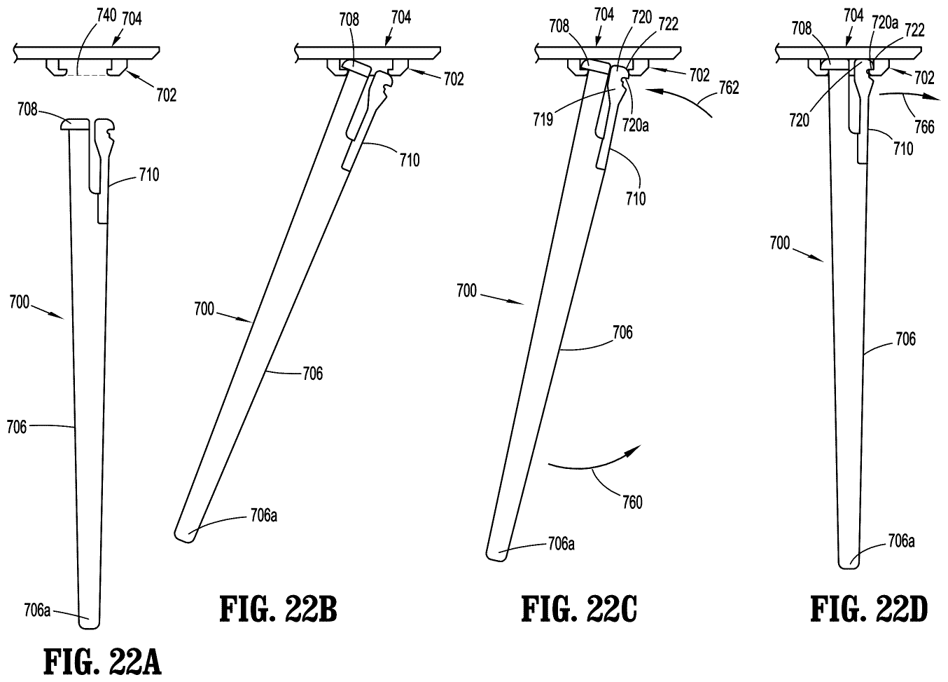

The table leg 706 includes a foot end 706a (FIG. 22A-22D) that is configured to engage a support surface, e.g., the floor, and a head end 706b configured to be coupled to the tabletop 704. The head end 706b includes a planar mounting surface 707. It is envisioned that the mounting surface 707 can be non-planar, e.g., curved. The head end 706b of the table leg 706 defines an elongate cutout 712 that receives the flexible tooth 710. In aspects of the disclosure, the cutout 712 is stepped and includes an upper end 712a and a lower end 712b, wherein the upper end 712a of the cutout 712 nearer the planar mounting surface 707 has a depth that is greater than the depth of the lower end of the cutout 712. In aspects of the disclosure, the cutout defines a mounting wall 714 that is positioned to facilitate mounting of the flexible tooth 710.

The flexible tooth 710 includes a lower end portion 710a and an upper end portion 710b. The lower end portion 710a defines two spaced bores 716 that extend through the lower end portion 710a of the flexible tooth 710 and are dimensioned to receive mounting screws 718 (FIG. 20). The mounting screws 718 are received through the bores 716 and are threaded into the mounting wall 714 within the cutout 712 to secure the flexible tooth 710 within the cutout 712 in cantilevered fashion.

The upper end portion 710b of the flexible tooth 710 includes an upper end 719 including a tab 720 that defines an engagement surface 720a. In aspects of the disclosure, the upper end 719 of the flexible tooth 710 includes an outer radiused surface 722. In some aspects of the disclosure, the upper end portion 710b of the flexible tooth 710 includes a portion of reduced width 724 that is positioned between the tab 720 and the lower end portion 710a to increase the flexibility of the central portion of the flexible tooth 710. In aspects of the disclosure, the tab 720 of the flexible tooth 710 extends upwardly from the cutout 712 and is positioned above the mounting surface 707 of the table leg 706.

In aspects of the disclosure, the cap 708 has a circular configuration although other configurations are envisioned, e.g., rectangular (FIG. 24). The cap 708 is mounted to the mounting surface 707 of the table leg 706 using, e.g., screws (not shown), and includes a first recess 726 on a first side of the cap 708 and a second recess 728 formed in a second side of the cap 708. The first recess 726 is positioned to receive the upper end 719 of the flexible tooth 710, and the second recess 728 is positioned to receive an alignment member 730 of the leg mount 702 when the leg assembly 700 is coupled to the leg mount 702. The second recess 728 is defined between two tabs 746 of the cap 708. In aspects of the disclosure, the first recess 726 and/or the second recess 728 can have rectangular configurations although other configurations are envisioned.

In aspects of the disclosure, the metal plate 711 can be interposed between the mounting surface 707 of the table leg 706 and the cap 708 to facilitate welding of the metal plate 711 to the upper end of the table legs 706 when the table legs 706 are formed from metal. It is envisioned that the metal plate 711 can have a configuration that corresponds to the configuration of the cap 708 and define a first recess 736 and a second recess 738 that have configurations that correspond to the configurations of the first and second recesses 726 and 728, respectively, of the cap 708. In aspects of the disclosure, the cap 708 is secured to the mounting surface 707 of the table leg 706 using screws or the like.

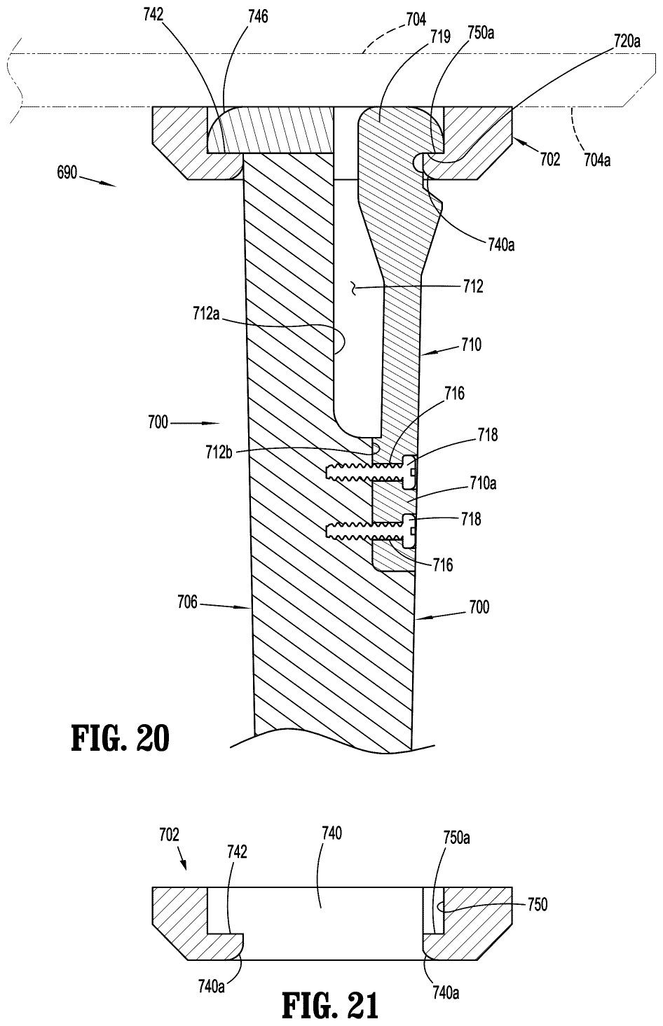

The leg mount 702 defines a central opening 740 that has a configuration that corresponds to the configuration of the cap 708. More specifically, the leg mount 702 includes an alignment member 730 that extends into the central opening 740 and is received within the second recess 728 of the cap 702 when the leg assembly 700 is coupled to the leg mount 702. The lower side of the central opening 740 is defined by radiused surfaces 740a (FIG. 21). The alignment member 730 is bound by two support surfaces 742 that are positioned to support the tabs 746 of the cap 708 when the leg assembly 700 is coupled to the leg mount 702. The cap 702 also defines cutout 750 that includes a locking surface 750a (FIG. 21) that is disposed on a side of the leg mount 712 opposite to the support surfaces 742.

In aspects of the disclosure, the leg mount 702 is secured to the bottom side 704a of the tabletop 704 using, for example, screws (not shown). It is envisioned that other types of securement devices or securement techniques can be used to secure the leg mount 702 to the bottom side 704a of the tabletop 704, e.g., adhesives.

FIGS. 22A-22D illustrate the leg assembly 700 as the leg assembly 700 is coupled to the tabletop 704 with the leg mounts 702. To attach the leg assembly 700 to the leg mount 702, the tabs 746 of the cap 708 are inserted through the central opening 740 at an angle and positioned on the support surfaces 742 of the cap 708 (FIG. 22B). Once the tabs 746 are engaged with the support surfaces 742, the leg assembly 700 is pivoted in the direction indicated by arrow 760 to pivot the upper end 719 of the flexible tooth 710 towards the central opening 740 of the leg mount 702 until the radiused surface 722 of the flexible tooth 710 engages the radiused surface 740a of the leg mount 702. When the radiused surface 722 of the flexible tooth 710 engages the radiused surface 740a of the leg mount 702, the flexible tooth 710 is biased inwardly in the direction of arrow 762 (FIG. 22C) until the engagement surface 720a of the tab 720 enters the central opening 740 and passes by the locking surface 750a of the cutout 750 of the leg mount 702. When the engagement surface 720a of the tab 720 passes by the locking surface 750a of the cutout 750 of the leg mount 702, the flexible tooth 710 returns in the direction indicated by arrow 766 to a non-deformed state in the tab 720 of the leg assembly 700 is engaged with the locking surface 750a of the leg mount 702.

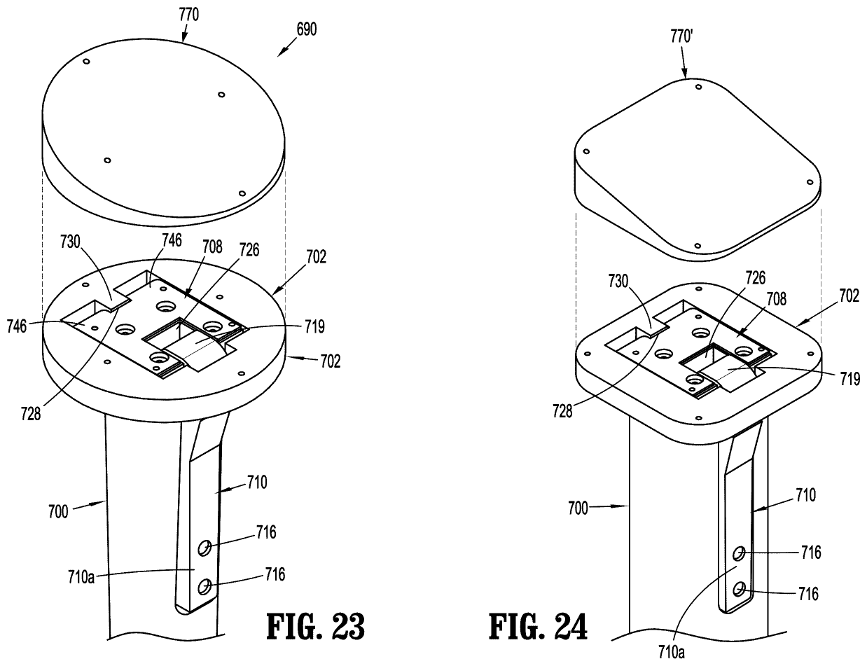

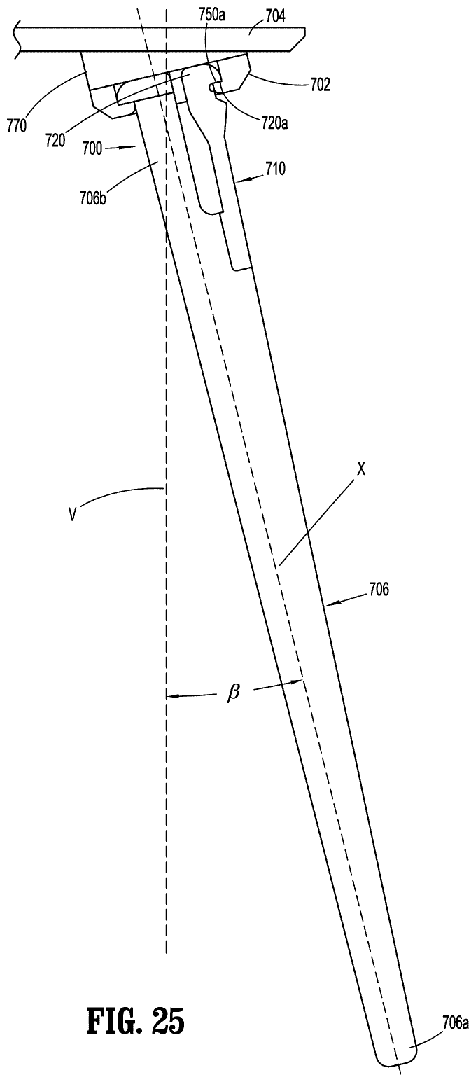

FIGS. 23-25 illustrate wedge 770 and 770′ that is secured to the tabletop 704 and to the leg mount 702 to position the leg mount 702 at an angle in relation to the tabletop 704. The wedge 770 allows the longitudinal axis “X” of the leg assembly 700 to be positioned at an angle β in relation to a vertical axis “V” (FIG. 25). The angle β of the wedge 770 can be selected to be any desirable angle and, for example, can be between about 10 degrees and about 30 degrees. In aspects of the disclosure, the configuration of the wedge 770 can be selected to match the configuration of the leg mount 702. For example, the wedge 770 (FIG. 23) can have a circular configuration, or in the alternative, the configuration of the wedge 770′ can be rectangular (FIG. 24).

The components of the flat pack, click-together furniture system 690 can be formed of any materials including those described above with respect to the furniture systems 200, 300, 400, 500, and 600.

Persons skilled in the art will understand that the structures and methods specifically described herein and illustrated in the accompanying figures are non-limiting exemplary aspects, and that the description, disclosure, and figures should be construed merely as exemplary of particular aspects. It is to be understood, therefore, that this disclosure is not limited to the precise aspects described, and that various other changes and modifications may be effectuated by one skilled in the art without departing from the scope or spirit of the disclosure. Additionally, it is envisioned that the elements and features illustrated or described in connection with one exemplary aspect may be combined with the elements and features of another without departing from the scope of this disclosure, and that such modifications and variations are also intended to be included within the scope of this disclosure. Indeed, any combination of any of the disclosed elements and features is within the scope of this disclosure. Accordingly, the subject matter of this disclosure is not to be limited by what has been particularly shown and described.

What is claimed:

1. A flat pack, click-together furniture system, comprising:
a tabletop having a bottom side;
a leg mount adapted to be mounted to the bottom side of the tabletop, the leg mount defining a central opening and having at least one support surface positioned adjacent one side of the central opening and a locking surface positioned adjacent a second side of the central opening, the at least one support surface and the locking surface facing upwardly towards the tabletop;
a cap having a configuration that corresponds to a configuration of the central opening, the cap including at least one tab positioned to be supported on the at least one support surface and defining a first recess, the first recess positioned on a side of the cap opposite to the at least one tab; and
a leg assembly including a table leg and a resilient tooth, the table leg having a foot end and a head end, the head end defining a cutout configured to receive the resilient tooth, the resilient tooth having a lower end portion and an upper end portion, the lower end portion adapted to be connected to the table leg to secure the resilient tooth within the cutout in cantilevered fashion, the upper end portion including an upper end having a tab including an engagement surface that is positioned to engage the locking surface of the leg mount, the upper end of the upper end portion received within the first recess of the cap.

2. The flat pack, click-together furniture system of claim 1, wherein the upper end of the upper end portion of the resilient tooth having an outer surface that is radiused.

3. The flat pack, click-together furniture system of claim 2, wherein the leg mount includes a lower side positioned adjacent the central opening that is radiused and engages the outer surface of the upper end of the upper end portion of the resilient tooth to urge the upper end portion inwardly into the cutout when the leg assembly is attached to the leg mount.

4. The flat pack, click-together furniture system of claim 1, further including a metal plate adapted to be connected to a lower surface of the cap.

5. The flat pack, click-together furniture system of claim 4, wherein the metal plate has a configuration that corresponds to the configuration of the cap.

6. The flat pack, click-together furniture system of claim 1, wherein the at least one support surface of the leg mount includes a first support surface and a second support surface.

7. The flat pack, click-together furniture system of claim 6, wherein the leg mount includes an alignment member that is positioned between the first support surface and the second support surface.

8. The flat pack, click-together furniture system of claim 7, wherein the cap defines a second recess that is positioned to receive the alignment member.

9. The flat pack, click-together furniture system of claim 1, wherein the leg mount has a circular configuration.

10. The flat pack, click-together furniture system of claim 1, wherein the leg mount has a rectangular configuration.

11. The flat pack, click-together furniture system of claim 1, further including a wedge member interposed between the leg mount and the bottom side of the tabletop.

12. The flat pack, click-together furniture system of claim 11, wherein the table leg defines a longitudinal axis, and the wedge member is configured to angle the table leg to define an angle with a vertical axis between about 10 degrees and about 30 degrees.

13. The flat pack, click-together furniture system of claim 1, wherein the cutout is stepped and has a depth that is larger adjacent the upper end portion of the resilient tooth as compared to a depth of the lower end portion of the resilient tooth.

14. The flat pack, click-together furniture system of claim 1, wherein the lower end portion of the resilient tooth is connected within the cutout with screws.

15. The flat pack, click-together furniture system of claim 14, wherein the lower end portion of the resilient tooth defines two spaced bores that receive the screws to secure the resilient tooth in cantilevered fashion within the cutout.

16. A leg assembly for a flat pack, click-together furniture system, comprising:
a table leg having a foot end and a head end, the head end defining a cutout;
a resilient tooth having a lower end portion and an upper end portion, the lower end portion adapted to be connected within the cutout of the table leg to secure the resilient tooth within the cutout in cantilevered fashion; and
a cap including at least one tab and defining a first recess, the first recess positioned on a side of the cap opposite to the at least one tab, the upper end of the upper end portion received within the first recess of the cap.

17. The leg assembly of claim 16, wherein the at least one tab includes a first tab spaced from a second tab.

18. The leg assembly of claim 17, wherein the first tab and the second tab define a second recess.

19. The leg assembly of claim 16, further including a metal plate interposed between the table leg and the cap.

20. The leg assembly of claim 19, wherein the metal plate is welded to the table leg.
